(19) United States
(12) Patent Application Publication
(10) Pub. No.: US 2025/0314931 A1
(43) Pub. Date: Oct. 9, 2025

(54) DISPLAY DEVICE

(71) Applicant: Japan Display Inc., Tokyo (JP)

(72) Inventors: Hirotaka HAYASHI, Tokyo (JP); Mamoru DOUYOU, Tokyo (JP)

(73) Assignee: Japan Display Inc., Tokyo (JP)

(21) Appl. No.: 19/095,063

(22) Filed: Mar. 31, 2025

(30) Foreign Application Priority Data
Apr. 9, 2024 (JP) 2024-062714

(51) Int. Cl. G02F 1/1343; G02F 1/1333; G02F 1/1362

(52) U.S. Cl. CPC G02F 1/134309; G02F 1/13338; G02F 1/133382; G02F 1/13439; G02F 1/136209; G02F 1/136272; G02F 1/136286

(57) ABSTRACT

According to one embodiment, the display device is a display device including a liquid crystal layer containing polymer dispersed liquid crystal. The display device includes a display panel having a display area where images are displayed and a surrounding area surrounding the display area. The display panel includes a transparent electrode provided in the surrounding area and capable of heating the surrounding area.

### CROSS-REFERENCE TO RELATED APPLICATION

This application is based upon and claims the benefit of priority from Japanese Patent Application No. 2024-062714, filed Apr. 9, 2024, the entire contents of which are incorporated herein by reference.

### FIELD

Embodiments described herein relate generally to a display device.

### BACKGROUND

In recent years, a display device comprising a display panel including a polymer dispersed liquid crystal layer (PDLC), light sources, and the like has been proposed. The polymer dispersed liquid crystal layer can switch a scattering state in which light is scattered and a transparent state in which light is transmitted.

The display device can display images in the scattered state. The user can visually recognize a background through the display panel by switching the display panel to the transparent state.

### BRIEF DESCRIPTION OF THE DRAWINGS

FIG. 1 is a view showing a configuration example of a display device according to a first embodiment.

FIG. 2 is a schematic cross-sectional view showing the display device according to the first embodiment.

FIG. 3 is a view showing a configuration example of a transparent electrode provided in a display panel according to the first embodiment.

FIG. 4 is a schematic plan view showing the display device according to the first embodiment.

FIG. 5 is a block diagram showing a control circuit according to the first embodiment.

FIG. 6 is a circuit diagram showing a display device according to the first embodiment.

FIG. 7 is a flowchart showing an example of heating control in the control circuit.

FIG. 8 is a view showing a configuration example that can be applied to a surrounding area.

FIG. 9 is a view showing a configuration example of a common electrode and a transparent electrode.

FIG. 10 is a schematic cross-sectional view showing a display panel along X-X line in FIG. 8.

FIG. 11 is a schematic cross-sectional view showing the display panel along XI-XI line in FIG. 8.

FIG. 12 is a view showing a configuration example of a counter-electrode and a display device according to a second embodiment.

FIG. 13 is a schematic cross-sectional view showing a display device according to a second embodiment.

FIG. 14 is a schematic cross-sectional view showing the display device according to the second embodiment.

FIG. 15 is a schematic cross-sectional view showing a display area of a display device according to a third embodiment.

FIG. 16 is a schematic cross-sectional view showing the display area of the display device according to the third embodiment.

FIG. 17 is a view showing a configuration example of a transparent electrode provided in a display panel according to a fourth embodiment.

FIG. 18 is a view showing a configuration example of the transparent electrode provided in the display panel according to the fifth embodiment.

FIG. 19 is a view showing a configuration example of the transparent electrode provided in the display panel according to the fifth embodiment.

### DETAILED DESCRIPTION

In general, according to one embodiment, the display device is a display device that comprises a liquid crystal layer containing polymer dispersed liquid crystal. The display device includes a display panel having a display area where images are displayed and a surrounding area surrounding the display area. The display panel includes a transparent electrode provided in the surrounding area and capable of heating the surrounding area.

According to such a configuration, a display device capable of improving the display quality can be provided.

Embodiments will be described hereinafter with reference to the accompanying drawings. The disclosure is a mere example, and arbitrary change of gist which can be easily conceived by a person of ordinary skill in the art naturally falls within the inventive scope.

In addition, in some cases, in order to make the description clearer, the widths, thicknesses, shapes and the like, of the respective parts are illustrated schematically in the drawings, rather than as an accurate representation of what is implemented. However, such schematic illustration is merely exemplary, and in no way restricts the interpretation of the invention. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

In the figures, an X-axis, a Y-axis and a Z-axis orthogonal to each other are described to facilitate understanding as needed. A direction along the X-axis is referred to as a first direction X, a direction along the Y-axis is referred to as a second direction Y, and a direction along the Z-axis is referred to as a third direction Z. Viewing various elements parallel to the third direction Z is referred to as plan view.

In the embodiments, a highly translucent liquid crystal display device to which polymer dispersed liquid crystal is applied (so-called transparent display device) is disclosed as an example of the display device. However, the configurations disclosed in the embodiments can also be applied to the other types of display devices.

### First Embodiment

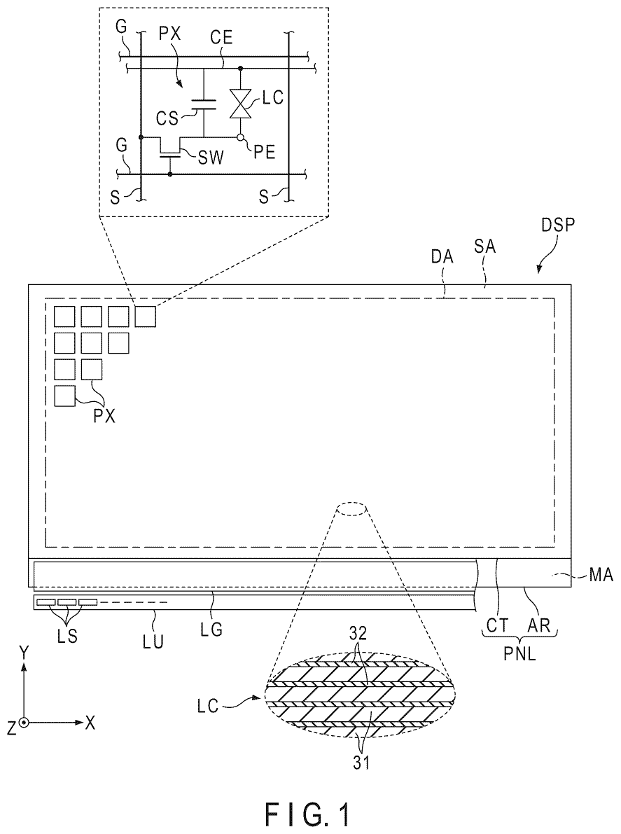

FIG. 1 is a view showing a configuration example of a display device DSP according to the present embodiment. In FIG. 1, the display device DSP is viewed in a direction opposite to the third direction Z.

The display device DSP comprises a display panel PNL, a light source unit LU and a light guide LG. In FIG. 1, the light source unit LU and the light guide LG are partly omitted by adding a break line.

The display panel PNL includes an array substrate AR and a counter-substrate CT stacked in the third direction Z. The counter-substrate CT is opposed to the array substrate AR. In FIG. 1, the shape of each of the array substrate AR and the counter-substrate CT is a rectangular shape which is elongated in the first direction X. However, the shape of each of the array substrate AR and the counter-substrate CT is not limited to this example.

The width of the array substrate AR in a second direction Y is greater than that of the counter-substrate CT in the second direction Y. The array substrate AR includes a mounting area MA provided at a portion which does not overlap with the counter-substrate CT. A wiring board to be described below and the like are mounted in the mounting area MA.

The display panel PNL has a display area DA for displaying an image and a frame-shaped surrounding area SA surrounding the display area DA. Each of the display area DA and the surrounding area SA is formed at a portion where the array substrate AR and the counter-substrate CT overlap.

As shown and expanded at an upper side of FIG. 1, a plurality of scanning lines G and a plurality of signal lines S are provided in the display area DA. The plurality of scanning lines G extend in the first direction X and are arranged in the second direction Y. The plurality of signal lines S extend in the second direction Y and are arranged in the first direction X. The plurality of signal lines S intersect the plurality of scanning lines G.

The display panel PNL further includes a liquid crystal layer LC which is sealed in between the array substrate AR and the counter-substrate CT. The liquid crystal layer LC is provided in the display area DA and the surrounding area SA. As enlarged and schematically shown at a lower side of FIG. 1, the liquid crystal layer LC is composed of polymer dispersed liquid crystal containing polymer 31 and liquid crystal molecules 32.

In one example, the polymer 31 is liquid crystal polymer. The polymer 31 is formed in a stripe shape extending along the first direction X and is aligned in the second direction Y. The liquid crystal molecules 32 are dispersed in gaps of the polymer 31 and aligned such that their major axis extends in the first direction X.

The polymer 31 and the liquid crystal molecules 32 have optical anisotropy or refractive anisotropy. The response performance of the polymer 31 to the electric field is lower than the response performance of the liquid crystal molecules 32 to the electric field.

For example, the alignment direction of the polymers 31 is hardly varied irrespective of the presence or absence of the electric field. In contrast, the alignment direction of the liquid crystal molecules 32 is varied in response to the voltage applied to the liquid crystal layer LC.

In a state in which the voltage is not applied to the liquid crystal layer LC, optical axes of the respective polymer 31 and liquid crystal molecules 32 are parallel to each other and the light made incident on the liquid crystal layer LC is not substantially scattered in the liquid crystal layer LC and transmitted (transparent state).

In a state in which the voltage is applied to the liquid crystal layer LC, the optical axes of the respective polymer 31 and liquid crystal molecules 32 intersect each other and the light made incident on the liquid crystal layer LC is scattered in the liquid crystal layer LC (scattered state).

The display area DA includes a plurality of pixels PX arrayed in a matrix in the first direction X and the second direction Y. Each of the pixels PX comprises a switching element SW, a pixel electrode PE, a counter-electrode CE, and a capacitance CS.

The switching element SW is formed of, for example, a thin-film transistor (TFT) and is electrically connected to a scanning line G and a signal line S. The pixel electrode PE is electrically connected to the switching element SW.

The liquid crystal layer LC (particularly, liquid crystal molecules 32) is driven by an electric field produced between the pixel electrode PE and the counter-electrode CE. The counter-electrode CE is provided commonly to a plurality of pixel electrodes PE. The capacitance CS is formed between, for example, an electrode having the same electric potential as the counter-electrode CE and an electrode having the same potential as the pixel electrode PE.

The light source unit LU and the light guide LG are provided along the mounting area MA. The light source unit LU comprises a plurality of light sources LS arranged in the first direction X. Each of the light source LS emits light toward the display panel PNL along the second direction Y via the light guide LG. As regards the light guide LG, for example, a lens such as a prism lens can be used.

For example, the light sources LS include a light emitting element which emits red light, a light emitting element which emits green light and a light emitting element which emits blue light. These light emitting elements may be aligned in the first direction X or stacked in the third direction Z. The light emitting element is, for example, a light emitting diode (LED).

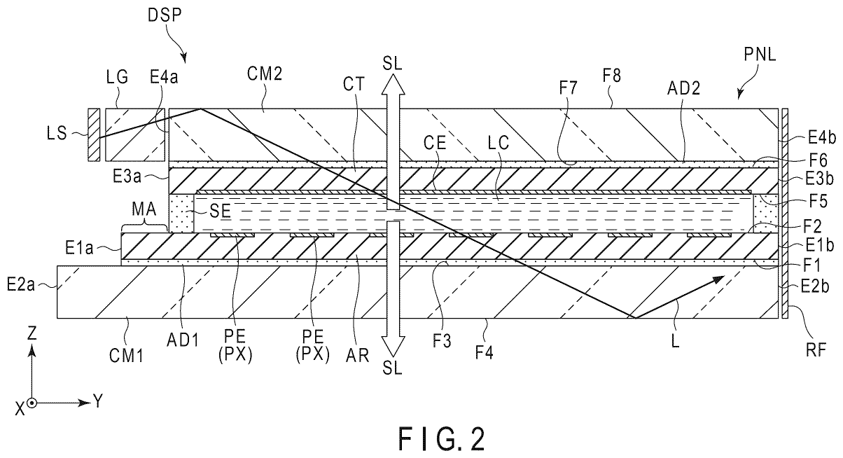

FIG. 2 is a schematic cross-sectional view showing the display device DSP according to the present embodiment. In FIG. 2, the structure of the display panel PNL and the like is schematically shown, and the elements such as the scanning lines G, the signal lines S, and the switching elements SW are omitted.

The array substrate AR and the counter-substrate CT are applied to each other by a sealing material SE. The sealing material SE has a shape which surrounds the display area DA. The space surrounded by the sealing material SE is filled with the liquid crystal layer LC.

The array substrate AR includes the plurality of pixel electrodes PE described above. The counter-substrate CT includes the above-described counter-electrode CE. The pixel electrodes PE face the counter-electrode CE through the liquid crystal layer LC.

The counter-electrode CE faces the plurality of pixel electrodes PE. The counter-electrode CE is provided in the display area DA and the surrounding area SA (shown in FIG. 1). The liquid crystal layer LC is located between the plurality of pixel electrodes PE and the counter-electrode CE.

The plurality of pixel electrodes PE and the counter-electrode CE are formed on transparent insulating substrates provided in the array substrate AR and the counter-substrate CE, respectively. These insulating substrates are formed of, for example, glass. However, the insulating substrates may be formed of plastic. The pixel electrodes PE and the counter-electrode CE are formed of, for example, a transparent conductive material such as indium tin oxide (ITO) or indium zinc oxide (IZO).

In one example, the pixel electrodes PE and the counter-electrode CE are covered with alignment films to be described below, which are formed in the array substrate AR and the counter-substrate CT, respectively. Incidentally, the layout of the pixel electrodes PE and the common electrode CE is not limited to this example.

The display panel PNL may further include a cover member CM1 and a cover member CM2. These cover members CM1 and CM2 are transparent, and are, for example, cover glasses formed of glass. As another example, the cover members CM1 and CM2 may be formed of plastic.

The array substrate AR has a main surface F1, a main surface F2 on a side opposite to the main surface F1, and side surfaces E1a and E1b that connect the main surfaces F1 and F2 to each other. The cover member CM1 has a main surface F3 facing the main surface F1, a main surface F4 on a side opposite to the main surface F3, and side surfaces E2a and E2b that connect the main surfaces F3 and F4 to each other. The main surfaces F1 and F3 are applied to each other by a transparent first adhesive layer AD1. The first adhesive layer AD1, for example, an optical clear adhesive (OCA).

The counter-substrate CT has a main surface F5 facing the main surface F2 through the liquid crystal layer LC, a main surface F6 on a side opposite to the main surface F5, and side surfaces E3a and E3b connecting the main surfaces F5 and F6 to each other. The cover member CM2 has a main surface F7 facing the main surface F6, a main surface F8 on a side opposite to the main surface F7, and side surfaces E4a and E4b that connect the main surfaces F7 and F8 to each other. The main surfaces F6 and F7 are attached to each other by a transparent second adhesive layer AD2. The second adhesive layer AD2 is OCA similarly to the first adhesive layer AD1.

All of the side surfaces Ela, E2a, E3a and E4a are located on the light source LS side (incident side). All of the side surfaces E1b, E2b, E3b and E4b are located on a side opposite to the light source LS (a side opposite to the incident side). The mounting area MA is formed in a portion which protrudes relative to the side surface E3a in the direction opposite to the second direction Y, in the array substrate AR.

The side surfaces E2a, E4a, E2b and E4b are flat surfaces parallel to the first direction X and the third direction Z, in the example shown in FIG. 2. However, the sectional shape of the side surfaces E2a, E4a, E2b and E4b is not limited to this example.

In the example shown in FIG. 2, a reflective material RF is provided in the vicinity of the side surfaces E1b, E2b, E3b and E4b. The reflective material RF is, for example, a reflective tape attached to the side surfaces E1b, E2b, E3b and E4b. As another example, the reflective material RF may be a reflective film formed in the side surfaces E1b, E2b, E3b and E4b.

The light source LS faces the side surface E4a in the example shown in FIG. 2. Incidentally, the light source LS may further face the side surface E3a. The light guide LG is provided between the side surface E4a and the light source LS. FIG. 2 shows an example of a path of light L emitted from the light source LS. The light L emitted from the light source LS passes through the light guide LG and is made incident on the side surface E4a.

This light L proceeds to the side opposite to the incident side while repeating total reflection between the main surface F8 and the main surface F4. The light L which has reached the side surfaces E1b, E2b, E3b and E4b is reflected by the reflective material RF and proceeds to the incident side while repeating total reflection between the main surface F8 and the main surface F4.

In the vicinity of the pixel PX in a transparent state, the light L is not substantially scattered in the liquid crystal layer LC. For this reason, light L does not substantially leak out of the cover member CM1 or CM2. In contrast, the light L is scattered in the liquid crystal layer LC, in the vicinity of the pixel PX in a scattered state. This scattered light SL is emitted from the cover members CM1 and CM2 and is visually recognized as a display image by the user. Gradation expression of the scattering degree (luminance) can also be implemented by defining the voltage applied to the pixel electrodes PE within a predetermined range in a step-by-step manner.

Incidentally, the external light made incident on the cover members CM1 and CM2 is not substantially scattered and passes through the liquid crystal layer LC, in the vicinity of the pixel PX in a transparent state. In other words, when the display panel PNL is viewed from the first cover member CM1 side, the background on the second cover member CM2 side can be visually recognized. In addition, when the display panel PNL is viewed from the second cover member CM2 side, the background on the first cover member CM1 side can be visually recognized.

For example, as a system for displaying an image by the display device DSP, a field sequential system of repeating a first subframe in which a red image is displayed by lighting up the red light emitting elements of the plurality of light sources LS, a second subframe in which a green image is displayed by lighting up the green light emitting elements, and a third subframe in which a blue image is displayed by lighting up the blue light emitting elements can be employed.

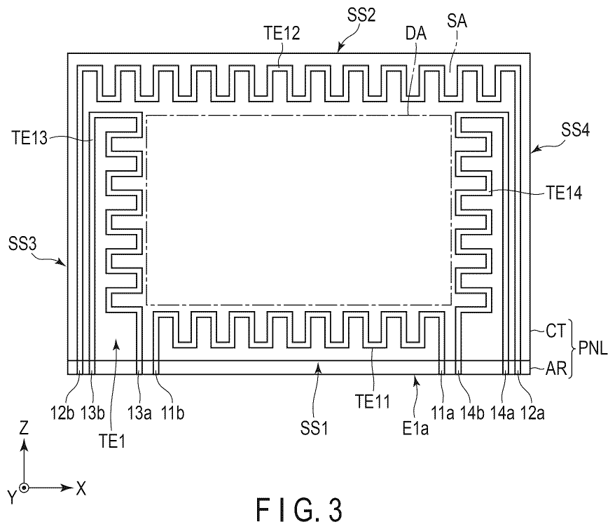

FIG. 3 is a view showing a configuration example of a transparent electrode TE1 provided in the display panel PNL according to the present embodiment. In FIG. 3, the display panel PNL is viewed in a direction opposite to the third direction Z. In FIG. 3, some of the elements constituting the display panel PNL, such as the cover members CM1 and CM2, are omitted.

As shown in FIG. 3, the display panel PNL has a first side surface SS1, a second side surface SS2, a third side surface SS3, and a fourth side surface SS4. The first side surface SS1 and the second side surface SS2 extend in the first direction X and are arranged at intervals in the second direction Y. The first side surface SS1 faces in the direction opposite to the second direction Y, and the second side surface SS2 faces in the second direction Y. In other words, the second side surface SS2 faces in the direction opposite to the first side surface SS1.

The first side surface SS1 is a surface located between the plurality of light sources LS (shown in FIG. 1) and the display area DA. The first side surface SS1 includes the side surfaces E3a and E4a (shown in FIG. 2). The second side surface SS2 includes the side surfaces E1b, E2b, E3b, and E4b (shown in FIG. 2).

The third side surface SS3 and the fourth side surface SS4 extend in the second direction Y and are arranged at intervals in the first direction X. The third side surface SS3 and the fourth side surface SS4 connect the first side surface SS1 and the second side surface SS2. The third side surface SS3 faces in the direction opposite to the first direction X, and the fourth side surface SS4 faces in the first direction X.

The display panel PNL further includes a transparent electrode TE1 provided in the surrounding area SA. The transparent electrode TEL is configured to be capable of heating the surrounding area SA. In other words, the transparent electrode TE1 functions as a heater to heat the surrounding area SA. The transparent electrode TEL is formed of, for example, a transparent conductive material.

The transparent electrode TEL is not provided in the display area DA, but is provided only in the surrounding area SA to surround the display area DA. In the present embodiment, the transparent electrode TE1 is provided on the array substrate AR. The transparent electrode TE1 includes electrodes TE11, TE12, TE13, and TE14, as shown in the example of FIG. 3.

The electrode TE11 is mainly provided between the display area DA and the first side surface SS1, the electrode TE12 is mainly provided between the display area DA and the second side surface SS2, the electrode TE13 is mainly provided between the display area DA and the third side surface SS3, and the electrode TE14 is mainly provided between the display area DA and the fourth side surface SS4.

The electrodes TE11, TE12, TE13, and TE14 are patterned into a predetermined shape. The electrodes TE11, TE12, TE13, and TE14 have, for example, a zigzag shape.

In the example shown, the zigzag shape is formed by connecting straight portions at right angles. In another example, straight portions may be connected by curved connecting portions. In yet another example, the straight portions may be connected at an angle other than a right angle to form the zigzag shape.

Incidentally, various shapes can be applied to the electrodes TE11, TE12, TE13, and TE14, and are not limited to the examples described above. For example, the electrodes TE11, TE12, TE13, and TE14 may have a meandering shape (a meander shape).

The total length of transparent electrode TE1 can be increased by forming the transparent electrode TE1 in the above-described shape. The electrical resistance of the electrodes TE11, TE12, TE13, and TE14 is thereby increased. As a result, the amount of heat generated in a case where the voltage is applied to the electrodes TE11, TE12, TE13, and TE14 can be increased.

The electrodes TE11, TE12, TE13, and TE14 extend to, for example, the mounting area MA. The electrode TE11 has end portions 11a and 11b. The electrode TE12 has end portions 12a and 12b. The electrode TE13 has end portions 13a and 13b. The electrode TE14 has end portions 14a and 14b.

Terminals (not shown) are provided in the mounting area MA at the end portions 11a and 11b, the end portions 12a and 12b, the end portions 13a and 13b, and the end portions 14a and 14b. The electrodes TE11, TE12, TE13, and TE14 are electrically connected to a first power supply circuit and a second voltage circuit, which will be described below.

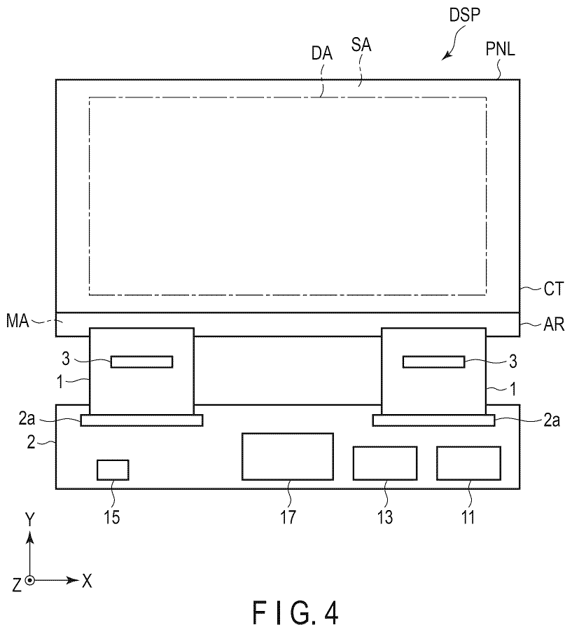

FIG. 4 is a schematic plan view showing the display device DSP according to the present embodiment. The display device DSP further comprises a plurality of wiring boards 1 and a control substrate 2. The plurality of wiring boards 1 are connected to the mounting area MA. The plurality of wiring boards 1 are, for example, flexible printed circuits.

For example, an IC chip 3 is provided on each of the plurality of wiring boards 1. The IC chip 3 includes, for example, a drive circuit for displaying images. Incidentally, the IC chip 3 may be provided on the display panel PNL or the control substrate 2. The number of wiring boards 1 may be one or may be three or more. The plurality of wiring boards 1 are connected to the control substrate 2 via the terminal 2a.

The control substrate 2 is electrically connected to the display panel PNL via the plurality of wiring boards 1. The control substrate 2 is, for example, a printed circuit board with greater rigidity than the wiring board 1.

The display device DSP further comprises a first power supply circuit 11, a second power supply circuit 13, a temperature sensor 15, and a control circuit 17. The first power supply circuit 11, the second power supply circuit 13, the temperature sensor 15, and the control circuit 17 are provided on, for example, the control substrate 2, but providing is not limited to this example.

The first power supply circuit 11 and the second power supply circuit 13 are circuits for applying a voltage to the transparent electrode TE1. More specifically, the first power supply circuit 11 is a circuit for applying a common voltage (Vcom) to the transparent electrode TE1, and the second power supply circuit 13 is a circuit for urging the transparent electrode TE1 to function as a heater. The voltage applied by the second power supply circuit 13 is changed as appropriate according to the material for forming the transparent electrode TE1, and the like.

The temperature sensor 15 detects an ambient temperature. In this example, the ambient temperature is the temperature around the display panel PNL. In other words, the ambient temperature is the temperature around the liquid crystal layer LC. In addition, the ambient temperature is also the temperature of the location where the display device DSP is installed.

The temperature sensor 15 detects the ambient temperature while, for example, the display device DSP is operating. The temperature sensor 15 is provided on the control substrate 2 as described above, but may also be provided on, for example, the display panel PNL. The temperature sensor 15 is, for example, an element for detecting the ambient temperature.

The control circuit 17 is a circuit that controls the drive of the display device DSP. More specifically, the control circuit 17 comprises a function of controlling the image display in the display area DA, and also comprises a function of controlling the voltage applied to the transparent electrode TE1, based on the temperature detected by the temperature sensor 15.

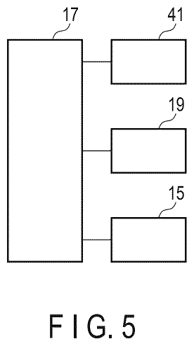

FIG. 5 is a block diagram including the control circuit 17 according to the present embodiment. The display device DSP further comprises a storage unit 19. The storage unit 19 stores various information such as programs for controlling the display device DSP and data including a predetermined temperature to be described below.

The control circuit 17 executes various processes by, for example, reading programs from the storage unit 19. The storage unit 19 may be configured as a part of the control circuit 17 or may be configured as a separate element from the control circuit 17. The storage unit 19 may be, for example, a memory, ROM, or the like, but is not limited to these examples.

The display device DSP further comprises a switching circuit 41. The switching circuit 41 functions as a switch that switches the connection path of the transparent electrode TE1. The switching circuit 41 is, for example, configured by combining a plurality of thin film transistors.

The control circuit 17 is electrically connected to the storage unit 19, the temperature sensor 15, and the switching circuit 41. As a result, the control circuit 17 can read necessary information from the storage unit 19, acquire the temperature information detected by the temperature sensor 15, and control the switching circuit 41.

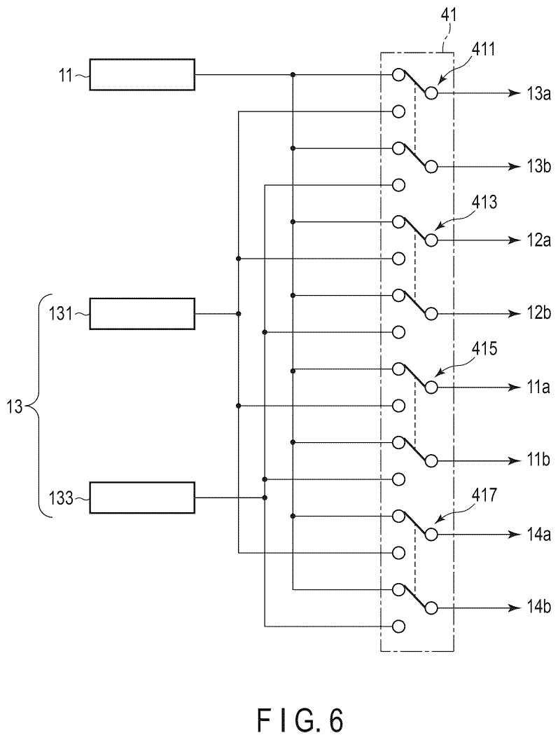

FIG. 6 is a circuit diagram showing the display device DSP according to the present embodiment. The second power supply circuit 13 includes power supply units 131 and 133. The power supply unit 131 applies a voltage of a potential different from a potential of the power supply unit 133. The switching circuit 41 includes switches 411, 413, 415, and 417.

One end of the switch 411 is connected to each of the end portions 13a and 13b of the electrode TE13, and the other end of the switch 411 is connected to each of the first power supply circuit 11 and the power supply units 131 and 133.

One end of the switch 413 is connected to each of the end portions 12a and 12b of the electrode TE12, and the other end of the switch 413 is connected to each of the first power supply circuit 11 and the power supply units 131 and 133.

One end of the switch 415 is connected to each of the end portions 11a and 11b of the electrode TE11, and the other end of the switch 415 is connected to each of the first power supply circuit 11 and the power supply units 131 and 133.

One end of the switch 417 is connected to each of the end portions 14a and 14b of the electrode TE14, and the other end of the switch 417 is connected to each of the first power supply circuit 11 and the power supply units 131 and 133.

When the switches 411, 413, 415, and 417 are connected to the first power supply circuit 11, a common voltage is applied to the transparent electrode TE1. In contrast, when the switches 411, 413, 415, and 417 are connected to the second power supply circuit 13, a current flows through the transparent electrode TE1.

Next, the heating control in the control circuit 17 will be described.

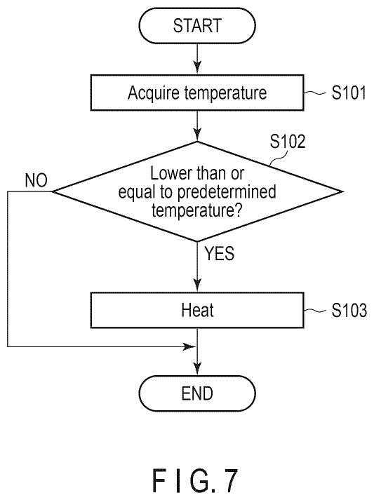

FIG. 7 is a flowchart showing an example of the heating control in the control circuit 17. In the display device DSP, the transparent electrode TE1 functions as a heater that heats the surrounding area SA through the heating control in the control circuit 17.

First, the control circuit 17 acquires ambient temperature information detected by the temperature sensor 15 (step S101). The timing at which the control circuit 17 acquires the ambient temperature information from the temperature sensor 15 may be the timing before image display or during image display in the display device DSP. In addition, the control circuit 17 may also be set such that the user can acquire the ambient temperature information at any timing.

Next, the control circuit 17 determines whether or not the ambient temperature is lower than or equal to a predetermined temperature, based on the ambient temperature acquired from the temperature sensor 15 (step S102). The predetermined temperature is set such that the transparent electrode TEL can heat the liquid crystal layer LC when, for example, the display device DSP is installed in a low-temperature environment such as a cold region. The predetermined temperature is stored in advance in, for example, the storage unit 19 (shown in FIG. 5).

If the ambient temperature is lower than or equal to the predetermined temperature (YES in step S102), the control circuit 17 executes the heating control (step S103). More specifically, the control circuit 17 controls the switching circuit 41 to connect the second power supply circuit 13 and the switches 411, 413, 415, and 417.

Since the transparent electrode TEL is formed of a transparent conductive material, the transparent electrode TE has a higher electrical resistance than a metallic material. A current flows through the transparent electrode TE1, and the transparent electrode TE1 thereby generates heat. The transparent electrode TE1 generates heat, and the surrounding area SA is thereby heated. Accordingly, the display panel PNL including the liquid crystal layer LC in the display area DA is heated.

For example, the heating control of the control circuit 17 may be set to end after a predetermined period of time has elapsed. For example, the heating control of the control circuit 17 may be set to be repeatedly executed until the ambient temperature exceeds the predetermined temperature.

If the ambient temperature is higher than the predetermined temperature (NO in step S102), the control circuit 17 does not execute the heating control. More specifically, the control circuit 17 controls the switching circuit 41 to connect the first power supply circuit 11 and the switches 411, 413, 415, and 417.

In other words, if the ambient temperature is higher than the predetermined temperature, the control circuit 17 controls applying the common voltage to the transparent electrode TE1. Thus, the control circuit 17 can control the voltage applied to the transparent electrode TE1, based on the temperature detected by the temperature sensor 15.

Next, a structure which can be applied to the surrounding area SA will be described. In one example, the area between the display area DA and the third side surface SS3, within the area where the transparent electrode TE1 is formed. The structure described below can also be applied to other areas.

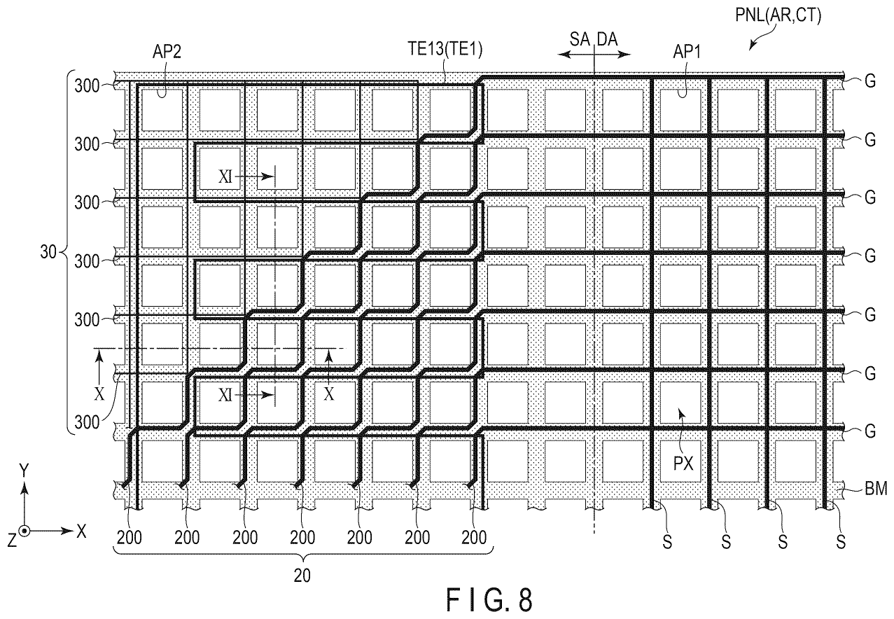

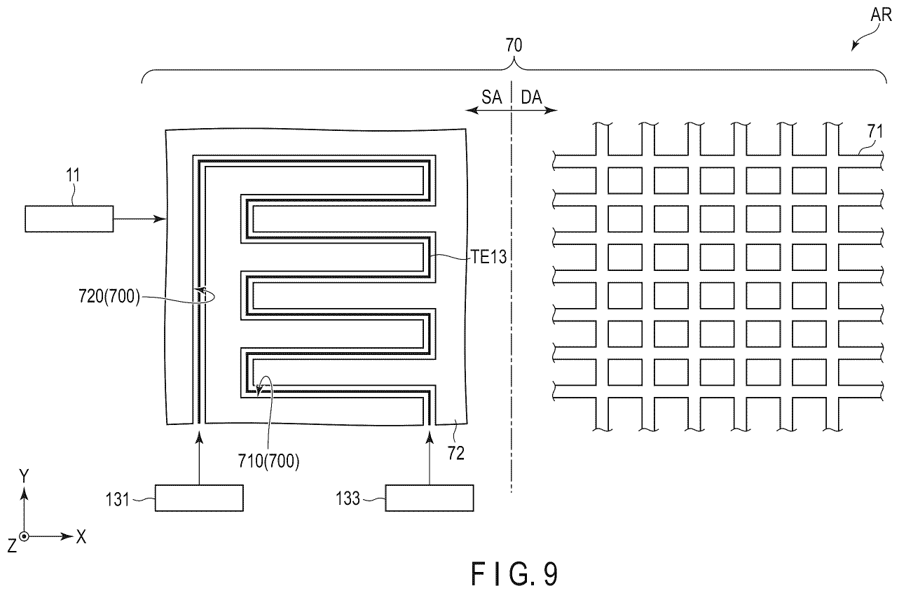

FIG. 8 is a view showing a configuration example that can be applied to the surrounding area SA. FIG. 9 is a view showing a configuration example of the common electrode 70 and the transparent electrode TE1. In FIG. 8 and FIG. 9, the display panel PNL is viewed in a direction opposite to the third direction Z.

The array substrate AR further includes a first wiring portion 20 provided in the surrounding area SA. The first wiring portion 20 is electrically connected to the plurality of scanning lines G provided in the display area DA. A voltage is applied to the plurality of scanning lines G from a drive circuit (not shown) via the first wiring portion 20. As shown in FIG. 8, the first wiring portion 20 includes a plurality of lines 200 each connected to the plurality of scanning lines G.

The plurality of scanning lines G are arranged at intervals in the second direction Y. Each of the plurality of lines 200 includes a part extending in the first direction X and a part extending in the second direction Y. The first wiring portion 20 is narrower along the second direction Y. In other words, for example, the first wiring portion 20 is formed in a stair-like manner by the plurality of lines 200.

The array substrate AR further includes a second wiring portion 30. A voltage of the same potential as the counter-electrode CE is applied to the second wiring portion 30. The second wiring portion 30 functions as, for example, a line which applies a common voltage to the counter-electrode CE of the counter substrate CT.

The second wiring portion 30 is provided in an area where the first wiring portion 20 is not provided, in the surrounding area SA. More specifically, the second wiring portion 30 is provided between the third side surface SS3 and the first wiring portion 20. Although not shown in the figure, the second wiring portion 30 is provided between the fourth side surface SS4 and the first wiring portion 20. In other words, the display area DA is located between the second wiring portions 30.

The second wiring portion 30 is formed to face the first wiring portion 20. More specifically, the second wiring portion 30 is greater in width along the second direction Y. The second wiring portion 30 includes a plurality of lines 300 as shown in FIG. 8. The first wiring portion 20 and the second wiring portion 30 are formed of the same material as the scanning lines G, the signal lines S, and the like.

By forming the second wiring portion 30, the appearance of the surrounding area SA can be improved when viewing the display panel PNL from the array substrate AR side. In addition, for example, the first wiring portion 20 and the second wiring portion 30 are formed with a pitch equivalent to that of the pixel PX. Therefore, the appearance of the surrounding area SA can be further improved. From the other viewpoint, the user can hardly recognize the boundary between the display area DA and the surrounding area SA.

The array substrate AR further includes a common electrode 70 as shown in FIG. 9. The common electrode 70 is provided in the display area DA and the surrounding area SA. A voltage of the same potential as the counter-electrode CE is applied to the common electrode 70. The common electrode 70 is connected to, for example, the first power supply circuit 11.

Accordingly, the common electrode 70 comprises a function of shielding the liquid crystal layer LC such that the liquid crystal layer LC does not respond by the voltage applied to the scanning lines G and signal lines S. The common electrode 70 is formed of, for example, the same material as the transparent electrode TE1.

The common electrode 70 includes a first portion 71 provided in the display area DA and a second portion 72 provided in the surrounding area SA. The second portion 72 is electrically connected to the first portion 71. The first portion 71 is formed in a grating pattern so as to overlap with the plurality of scanning lines G and signal lines S (shown in FIG. 8). In addition, the first portion 71 faces the pixel electrode PE in the display area DA to form the capacitance CS (shown in FIG. 1). The second portion 72 is formed over substantially the entire surrounding area SA.

The second portion 72 includes a slit 700 (first slit) as shown in FIG. 9. The electrode TE13 is provided along the slit 700. The electrode TE13 is insulated from the common electrode 70. The electrode TE13 is connected to, for example, the power supply units 131 and 133.

The slit 700 includes a plurality of first slit portions 710 extending in the first direction X, and a plurality of second slit portions 720 extending in the second direction Y and connected to the plurality of first slit portions 710. The slit 700 is formed in a zigzag shape by the plurality of first slit portions 710 and the plurality of second slit portions 720. The shape of the slit 700 is changed as appropriate in accordance with the shape of the transparent electrode TE1.

The electrode TE13 includes a portion formed along the first wiring portion 20 and the second wiring portion 30 in the first direction X. The electrode TE13 includes a portion formed along the first wiring portion 20 and the second wiring portion 30 in the second direction Y.

The display panel PNL further includes the light shielding layer BM as shown in FIG. 8. In FIG. 8, the light shielding layer BM is marked with dots. The light shielding layer BM is provided on the counter-substrate CT. The light shielding layer BM is formed in a grating pattern in the display area DA and the surrounding area SA.

The light shielding layer BM overlaps with the plurality of scanning lines G and the plurality of signal lines S in the display area DA, as shown in FIG. 8. In addition, the light shielding layer BM overlaps with the first wiring portion 20, the second wiring portion 30, and the electrode TE13 (transparent electrode TE1) in the surrounding area SA. When the second portion 72 is focused, the light shielding layer BM overlaps with each of the first slit portions 710 and the second slit portions 720.

The light shielding layer BM is formed of, for example, a metal material, but may also be formed of a black resin or the like. The light shielding layer BM suppresses the emission of light, which is reflected on the first wiring portion 20 and the second wiring portion 30 on the array substrate side, from the display panel PNL. In addition, the light shielding layer BM overlapping with the electrode TE13 can improve the appearance in the surrounding area SA.

The area of an aperture AP1 of the light shielding layer BM in the display area DA is equal to, for example, the area of an aperture AP2 of the light shielding layer BM in the surrounding area SA. In this example, the term equal may imply an error which does not affect the appearance of the display area DA and the surrounding area SA in the display device DSP. As a result, the user can hardly recognize the boundary between the display area DA and the surrounding area SA.

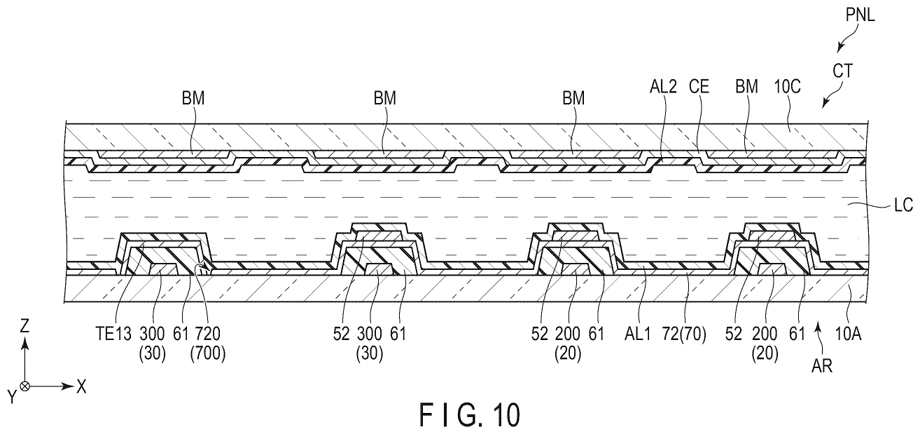

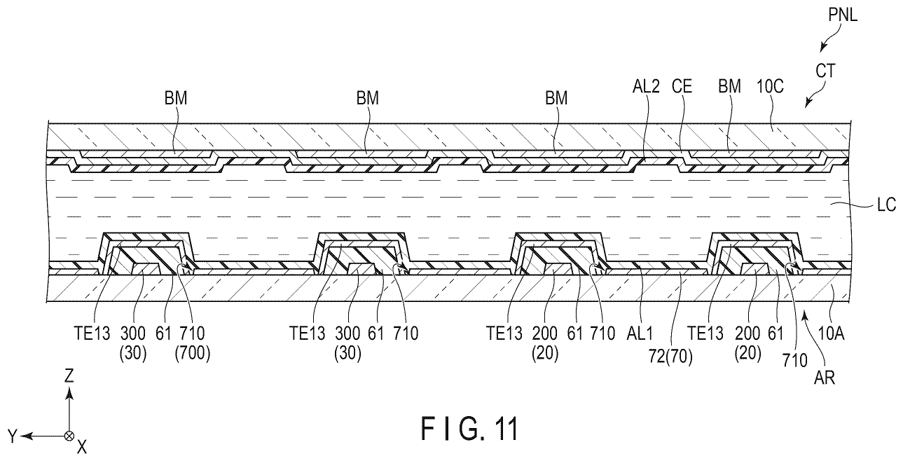

FIG. 10 is a schematic cross-sectional view showing the display panel PNL along X-X line in FIG. 8. FIG. 11 is a schematic cross-sectional view showing the display panel PNL along XI-XI line in FIG. 8. The display panel PNL is viewed in the second direction Y, in FIG. 10, and the display panel PNL is viewed in the first direction X, in FIG. 11. In FIG. 10 and FIG. 11, some of the components of the display panel PNL are omitted.

The first wiring portion 20 and the second wiring portion 30 described above are provided on a transparent insulating substrate 10A of the array substrate AR. Each of the first wiring portion 20 and the second wiring portion 30 is covered with an insulating film 61. The insulating film 61 is, for example, a transparent organic insulating film of an acrylic resin or the like. The insulating film 61 comprises a function of planarizing the unevenness caused by the first wiring portion 20 and the second wiring portion 30 and the like.

The common electrode 70 faces the counter-electrode CE through the liquid crystal layer LC. The second portion 72 of the common electrode 70 covers the upper surface and side surfaces of the insulating film 61. The second portion 72 includes a first slit portion 710 and a second slit portion 720. The insulating film 61 is exposed through the slit 700.

The electrode TE13 is provided in the slit 700 (first slit portions 710 and second slit portions 720) as described with reference to FIG. 9. For example, the electrode TE13 is formed in the same layer as the common electrode 70. The electrode TE13 overlaps with the first wiring portion 20 and the second wiring portion 30 through the insulating film 61. For example, electrode TE13 covers the upper surface and the side surfaces of the insulating film 61.

As shown in FIG. 10, the array substrate AR may further include auxiliary line 52. The auxiliary line 52 is in contact with the second portion 72 above the first wiring portion 20. The auxiliary line 52 is not provided above the electrode TE13. In other words, the auxiliary line 52 is not in contact with the electrode TE13.

A common voltage is applied to the auxiliary line 52. By providing the auxiliary line 52 in this manner, the resistance of the common electrode 70 can be reduced. Although not shown in the figures, the auxiliary line 52 may be further provided to be in contact with the first portion 71.

In the counter-substrate CT, the above-described light shielding layer BM is provided on a transparent insulating substrate 10C. The counter-electrode CE covers the light shielding layer BM and the insulating substrate 10C. In other words, the light shielding layer BM is provided between the insulating substrate 10C and the counter-electrode CE. The light shielding layer BM is in contact with the counter-electrode CE.

The light shielding layer BM overlaps with the insulating film 61. When the electrode TE13 is focused, the light shielding layer BM overlaps with the entire electrode TE13. From the other viewpoint, the light shielding layer BM overlaps with the first slit portions 710 and the second slit portions 720. The width of the light shielding layer BM is greater than the width of the electrode TE13 in the examples shown in FIG. 10 and FIG. 11.

The display panel PN1 further comprises alignment films AL1 and AL2. The alignment film AL1 is provided on the array substrate AR, and the alignment film AL2 is provided on the counter-substrate CT. The liquid crystal layer LC is provided between the first alignment film AL1 and the second alignment film AL2.

The alignment film AL1 covers the auxiliary line 52, the common electrode 70, and the electrode TE13. The auxiliary line 52 is located between alignment film AL1 and the upper surface of the common electrode 70. In contrast, the upper surface of electrode TE13 is in contact with the alignment film AL1. The alignment film AL2 covers the counter-electrode CE.

According to the display device DSP configured as described above, the display quality can be improved. For example, when the ambient temperature is low (in a low-temperature environment), the response speed of the liquid crystal molecules 32 (shown in FIG. 1) may decrease. Such a reaction of the liquid crystal layer LC may cause degradation in display quality.

In the present embodiment, the transparent electrode TE1 is configured to be capable of generating heat. By generating heat in the transparent electrode TE1 in the surrounding area SA, the liquid crystal layer LC is heated, and the temperature of the liquid crystal layer LC becomes higher than the ambient temperature, and the response speed of the liquid crystal molecules 32 is difficult to decrease.

As a result, the display quality can be improved in the display device DSP. From the other viewpoint, in the present embodiment, the display device DSP is less likely to be constrained by the usage conditions such as the ambient temperature.

For example, the transparent electrode TE1 is controlled independently of the image display control in the display area DA. Accordingly, the surrounding area SA can be heated by the transparent electrode TE1 at the timing different from the image display drive timing. For example, by heating the transparent electrode TE1 before the image display, the image can be displayed quickly when the display starts.

Furthermore, in the present embodiment, heaters for heating the display panel PNL do not need to be provided separately. As a result, inconvenience that the display device DSP may become larger or heavier by providing heaters can be suppressed.

In the present embodiment, the transparent electrode TE1 is formed of the same material as the common electrode 70. As a result, transparent electrode TE1 can be formed in the same process as the process of forming the common electrode 70. As a result, manufacturing costs can be reduced.

In the present embodiment, the counter-substrate CT includes a light shielding layer that overlaps with the transparent electrode TE1. When a potential difference occurs between the transparent electrode TE1 and the counter-electrode CE, the liquid crystal molecules 32 respond to this potential difference. This response of the liquid crystal layer LC may cause the appearance of the surrounding area SA to be deteriorated. In the present embodiment, the light shielding layer BM is provided to overlap with the transparent electrode TE1. As a result, the response of the liquid crystal molecules 32 caused by the potential difference can hardly affect the appearance of the surrounding area SA.

In the present embodiment, the control circuit 17 executes heating control based on the ambient temperature detected by the temperature sensor 15. For example, if the ambient temperature is normal, heating control is not executed, and the power consumption of the display device DSP can be suppressed.

As described above, the display quality can be improved according to the configuration of the present embodiment. In addition, various desirable advantages can be obtained from the present embodiment.

Incidentally, the heating control in the control circuit 17 is not limited to the above-described example. The transparent electrode TE1 includes, for example, the electrodes TE11, TE12, TE13, and TE14. Therefore, the control circuit 17 may control each of the electrodes TE11, TE12, TE13, and TE14, independently.

Accordingly, for example, the heat generation amount in each area can be controlled in accordance with the distribution of the ambient temperature. Furthermore, the transparent electrode TE1 may be configured to be controllable in response to partial driving such as displaying images in only specific areas of the display area DA. Incidentally, the transparent electrode TE1 includes the electrodes TE11, TE12, TE13, and TE14, but may also be composed of more or fewer electrodes. The configuration of the switching circuit 41 is changed as appropriate, depending on the number of electrodes constituting the transparent electrode TE1, or the like.

In addition, the control circuit 17 may control to change the amount of heat generated at the counter-electrode CE in accordance with, for example, the elapsed time. More specifically, the control circuit 17 may control the voltage applied to the transparent electrode TEL so as to increase the amount of heat generated at the start of heating control and decrease the amount of heat generated in accordance with the elapse of time.

By increasing the amount of heat generated at the start of heating control, the temperature of the liquid crystal layer LC can be quickly increased, and stable image display of the display device DSP can be executed quickly. In addition, the control circuit 17 may control the transparent electrode TEL to generate heat at any time during the image display.

The display device DSP may also comprise a sensor for detecting the temperature of the liquid crystal layer LC. As a result, the control circuit 17 may control the voltage applied to the transparent electrode TE1 so as to maintain a constant temperature of the liquid crystal layer LC, based on the sensor.

Next, other embodiments will be described. The same portions as those of the first embodiment can be applied to portions that are not particularly mentioned in configurations of the following embodiments.

### Second Embodiment

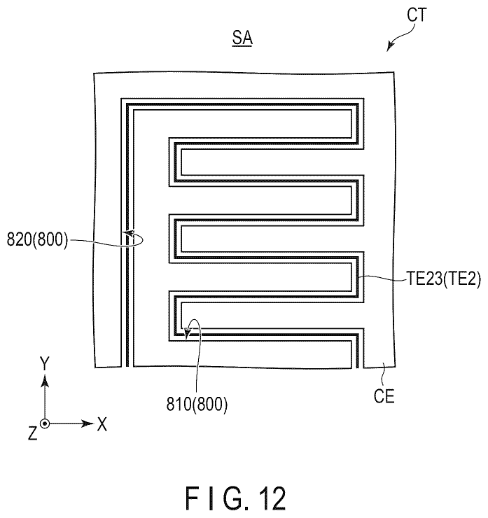

FIG. 12 is a view showing a configuration example of a counter-electrode CE and a transparent electrode TE2 of a display device DSP according to the present embodiment. FIG. 12 illustrates an area between a display area DA and a third side surface SS3 in a surrounding area SA. The structure described below can also be applied to other areas. The present embodiment is different from the first embodiment in that a transparent electrode capable of generating heat is provided on a counter-substrate CT.

A display panel PNL includes a transparent electrode TE2 provided on the counter-substrate CT. In the present embodiment, the transparent electrode TE2 functions as a heater that heats the surrounding area SA. The transparent electrode TE2 is also provided between the display area DA and a first side surface SS1, between the display area DA and a second side surface SS2, and between the display area DA and a fourth side surface SS4.

The same shape as the shape of the transparent electrode TE1 shown in FIG. 3 can be applied to the transparent electrode TE2. More specifically, the transparent electrode TE2 has a zigzag shape. In the example shown in the figure, an electrode TE23 of the transparent electrode TE2 is provided between the third side surface SS3 and the display area DA. For example, the transparent electrode TE2 is formed of a transparent conductive material to form the counter-electrode CE.

A voltage is applied to the transparent electrode TE2 via a connection member (not shown) that is different from the connection member connected to the counter-electrode CE. The connection member is often referred to as a transfer.

The counter-electrode CE includes a slit 800 (second slit) in the surrounding area SA. The transparent electrode TE2 is provided along the slit 800. The transparent electrode TE2 is insulated from the counter-electrode CE.

The slit 800 includes a plurality of first slit portions 810 extending in the first direction X, and a plurality of second slit portions 820 extending in the second direction Y and connected to the plurality of first slit portions 810. The slit 800 is formed in a zigzag shape by the plurality of first slit portions 810 and the plurality of second slit portions 820. The shape of the slit 800 is changed as appropriate in accordance with the shape of the transparent electrode TE2.

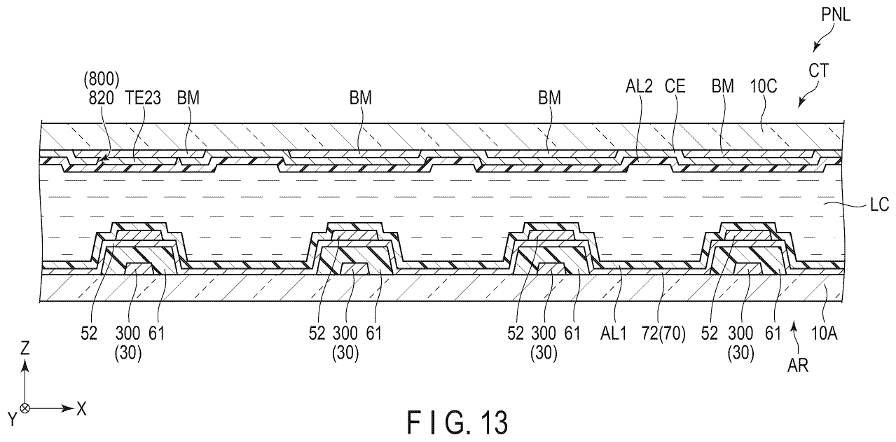

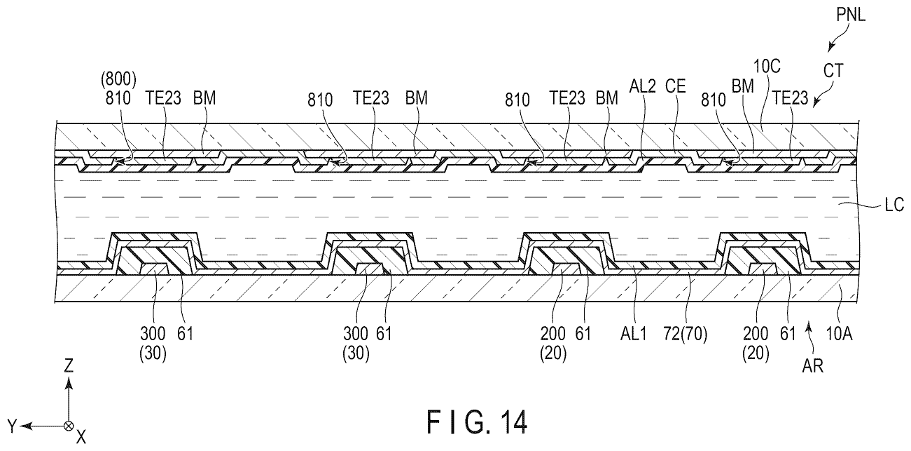

FIG. 13 and FIG. 14 are schematic cross-sectional views showing the display panel PNL according to the present embodiment. FIG. 13 and FIG. 14 illustrate an area between the display area DA and the third side surface SS3, in the surrounding area SA.

The display panel PNL is viewed in the second direction Y, in FIG. 13, and the display panel PNL is viewed in the first direction X, in FIG. 14. In FIG. 13 and FIG. 14, some of the components of the display panel PNL are omitted.

The electrode TE23 is provided in the slit 800 (first slit portions 810 and second slit portions 820) as described with reference to FIG. 12. For example, the electrode TE23 is formed in the same layer as the counter-electrode CE.

A part of the light shielding layer BM is exposed from the first slit portions 810 and the second slit portions 820. The electrode TE23 overlaps with the light-shielding layer BM. More specifically, the electrode TE23 is in contact with the light shielding layer BM. The electrode TE23 is provided between the light shielding layer BM and the alignment film AL2. The electrode TE23 overlaps with the first wiring portion 20 and the second wiring portion 30 through the liquid crystal layer LC.

The same advantages as those of the first embodiment can also be obtained from the configuration of the present embodiment.

### Third Embodiment

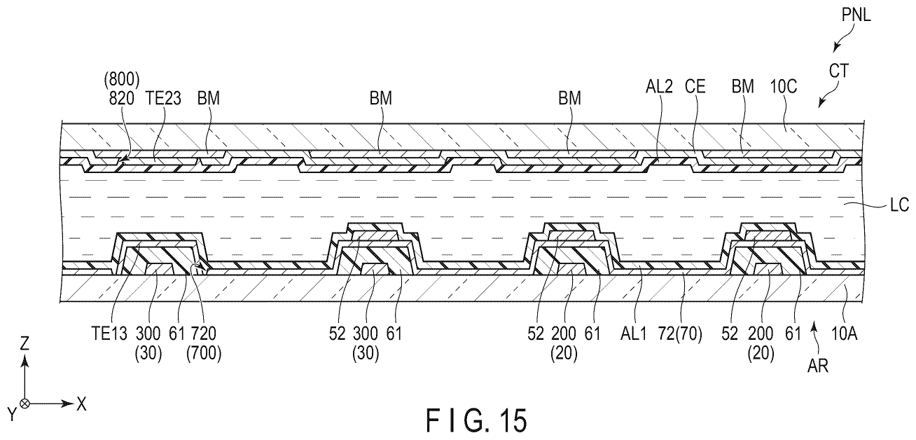

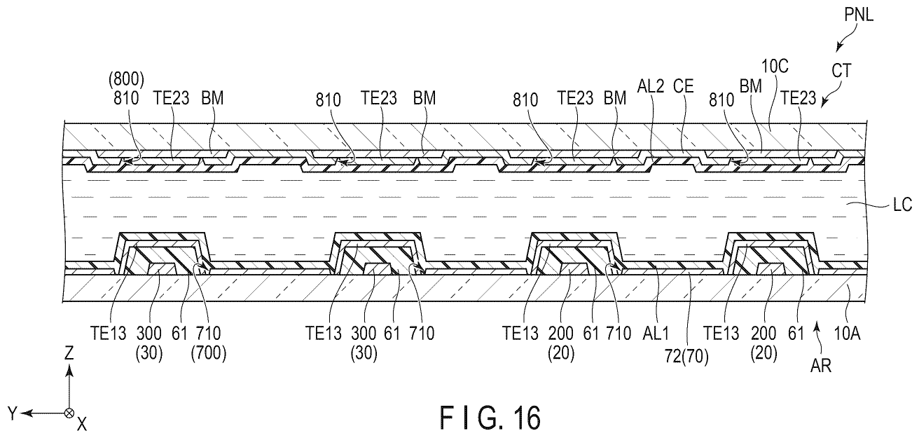

FIG. 15 and FIG. 16 are schematic cross-sectional views showing a display panel PNL of a display device DSP according to the present embodiment. FIG. 15 and FIG. 16 show a cross-section of a surrounding area SA of the display panel PNL. The display panel PNL is viewed in the second direction Y, in FIG. 15, and the display panel PNL is viewed in the first direction X, in FIG. 16. In FIG. 15 and FIG. 16, some of the components of the display panel PNL are omitted.

The present embodiment is different from the first embodiment in that a transparent electrode TE2 capable of generating heat is further provided on a counter-substrate CT. In the present embodiment, each of the transparent electrodes TE1 and TE2 functions as a heater that heats the surrounding area SA.

The display panel PN includes a transparent electrode TE1 provided on the array substrate AR and a transparent electrode TE2 provided on the counter-substrate CT. In the present embodiment, a slit 700 formed in a second portion 72 corresponds to a first slit, and a slit 800 formed in a counter-electrode CE corresponds to a second slit.

For example, the transparent electrode TE1 has the same shape as the transparent electrode TE2. For example, the shape of the transparent electrode TE1 matches the shape of the transparent electrode TE2 when viewed in the direction opposite to the third direction Z. Incidentally, the shape of the transparent electrode TE1 may be different from the shape of the transparent electrode TE2.

The light shielding layer BM overlaps with each of the transparent electrodes TEL and TE2. When the slits 700 and 800 are focused, the light shielding layer BM overlaps with each of the slits 700 and 800.

The same advantages as those of the first and second embodiments can also be obtained from the configuration of the present embodiment. In addition, in the present embodiment, the transparent electrodes TE1 and TE2 capable of generating heat are provided on the array substrate AR and the counter-substrate CT.

As a result, the display device DSP of the present embodiment has a larger amount of heat generation per unit area of the surrounding area SA than the display device DSP of each of the above-described embodiments. As a result, the display device DSP of the present embodiment can stably display images even in a lower temperature environment.

In the present embodiment, the transparent electrode TE1 faces the transparent electrode TE2 in the third direction Z. A potential difference is less likely to occur between the transparent electrode TE1 and the transparent electrode TE2, and the liquid crystal layer LC provided between the transparent electrode TE1 and the transparent electrode TE2 is less likely to respond. Therefore, the light shielding layer BM may not be provided in the position overlapping with the transparent electrodes TE1 and TE2.

Incidentally, the amount of heat generated by transparent electrode TE1 may be greater or smaller than the amount of heat generated by transparent electrode TE2. In addition, the amount of heat generated by transparent electrode TE1 may be equal to the amount of heat generated by transparent electrode TE2.

### Fourth Embodiment

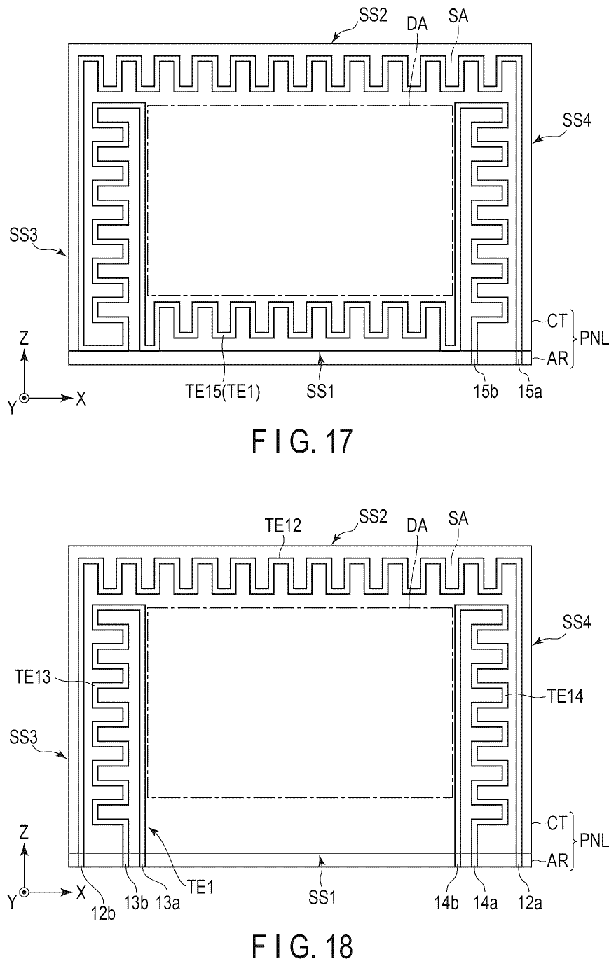

FIG. 17 is a view showing a configuration example of a transparent electrode TE1 provided in the display panel PNL according to the present embodiment. The present embodiment is different from the first embodiment in that the transparent electrode TEL is formed by a single electrode. The configuration of the transparent electrode TE1 in the present embodiment can also be applied to a transparent electrode TE2 provided on a counter-substrate CT.

In the present embodiment as well, the transparent electrode TE1 is provided between the display area DA and a first side surface SS1, between the display area DA and a second side surface SS2, between the display area DA and a third side surface SS3, and between the display area DA and a fourth side surface SS4.

The transparent electrode TEL is formed by a single electrode TE15. The electrode TE15 includes end portions 15a and 15b, on which terminals (not shown) are provided. The positions at which the end portions 15a and 15b are formed are not limited to the positions shown in the figure, but can be formed at any positions.

The same advantages as those of the first embodiment can also be obtained in the present embodiment. By forming the transparent electrode TE1 with a single electrode, the total length of the transparent electrode TEL can be increased.

### Fifth Embodiment

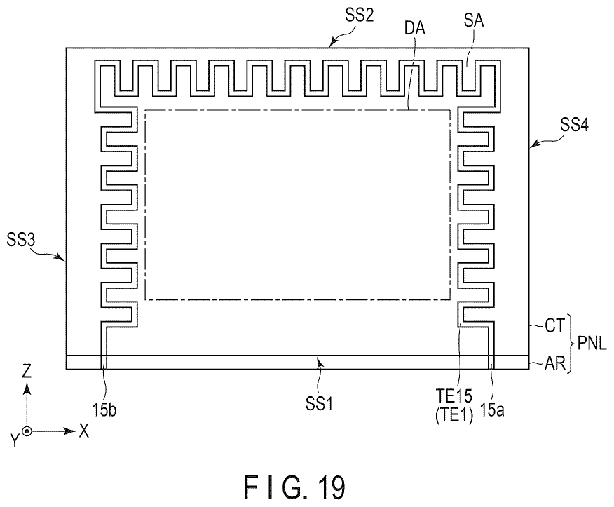

FIG. 18 and FIG. 19 are views showing a configuration example of a transparent electrode TE1 provided in the display panel PNL according to the first embodiment. The present embodiment is different from each of the above-described embodiments in that the transparent electrode TEL is not provided between a display area DA and a first side surface SS1. The configuration of the transparent electrode TE1 in the present embodiment can also be applied to a transparent electrode TE2 provided on a counter-substrate CT.

The transparent electrode TEL is formed by a plurality of electrodes TE12, TE13, and TE14 in the example shown in FIG. 18, and the transparent electrode TE1 is formed by a single electrode TE15 in the example shown in FIG. 19.

The same advantages as those of the first embodiment can also be obtained in the present embodiment. In the present embodiment, the transparent electrode TE1 is not provided between the display area DA and the first side surface SS1. In other words, the transparent electrode TE1 is not provided between the display area DA and the light source LS.

Accordingly, optical influence (interference, scattering, reflection, and the like) caused by the transparent electrode TE1, on the light emitted from the light source LS, can be suppressed. By making the light, which is emitted from the light source LS, certainly incident from the first side surface SS1, the efficiency of use of light emitted from the light source LS can be improved. As a result, the display quality can be further improved.

All of display devices that can be implemented by a person of ordinary skill in the art through arbitrary design changes to the display devices described above as embodiments of the present invention come within the scope of the present invention as long as they are in keeping with the spirit of the present invention.

Various types of the modified examples are easily conceivable within the category of the ideas of the present invention by a person of ordinary skill in the art and the modified examples are also considered to fall within the scope of the present invention. For example, the above embodiments with addition, deletion, and/or designed change of their structural elements by a person having ordinary skill in the art, or the above embodiments with addition, omission, and/or condition change of their processes by a person having ordinary skill in the art are encompassed by the scope of the present inventions without departing the spirit of the inventions.

In addition, the other advantages of the aspects described in the embodiments, which are obvious from the descriptions of the present specification or which can be arbitrarily conceived by a person of ordinary skill in the art, are considered to be achievable by the present invention as a matter of course.

What is claimed is:

1. A display device comprising a liquid crystal layer containing polymer dispersed liquid crystal, the display device comprising:
a display panel having a display area where images are displayed and a surrounding area surrounding the display area, wherein
the display panel includes a transparent electrode provided in the surrounding area and capable of heating the surrounding area.

2. The display device of claim 1, wherein
the transparent electrode is not provided in the display area, but only in the surrounding area.

3. The display device of claim 1, wherein
the transparent electrode has a zigzag shape.

4. The display device of claim 1, wherein
the display panel further includes an array substrate including a plurality of pixel electrodes provided in the display area, and a counter-substrate overlapping with the array substrate,
the counter-substrate includes a counter-electrode provided in the display area and the surrounding area to face the plurality of pixel electrodes,
the liquid crystal layer is provided between the array substrate and the counter-substrate, and
the transparent electrode is provided on the array substrate.

5. The display device of claim 4, wherein
the array substrate further includes a common electrode which faces the counter-electrode and to which a voltage of the same potential as the counter-electrode is applied,
the common electrode includes a first portion provided in the display area, and a second portion provided in the surrounding area and connected to the first portion, and
the second portion includes a first slit where the transparent electrode is provided.

6. The display device of claim 5, wherein
the array substrate further includes an auxiliary line to which a voltage of the same potential as the counter-electrode is applied, and
the auxiliary line is in contact with the second portion, and is not in contact with the transparent electrode.

7. The display device of claim 1, wherein
the display panel further includes an array substrate including a plurality of pixel electrodes provided in the display area, and a counter-substrate overlapping with the array substrate,
the counter-substrate includes a counter-electrode provided in the display area and the surrounding area to face the plurality of pixel electrodes,
the liquid crystal layer is provided between the array substrate and the counter-substrate, and
the transparent electrode is provided on the counter-substrate.

8. The display device of claim 7, wherein
the counter-electrode includes a second slit where the transparent electrode is provided, in the surrounding area.

9. The display device of claim 1, wherein
the display panel further includes an array substrate including a plurality of pixel electrodes provided in the display area, and a counter-substrate overlapping with the array substrate,
the counter-substrate includes a counter-electrode provided in the display area and the surrounding area to face the plurality of pixel electrodes,
the liquid crystal layer is provided between the array substrate and the counter-substrate, and
the transparent electrode is provided on each of the array substrate and the counter-substrate.

10. The display device of claim 9, wherein
the array substrate further includes a common electrode which faces the counter-electrode and to which a voltage of the same potential as the counter-electrode is applied,
the common electrode includes a first portion provided in the display area, and a second portion provided in the surrounding area and connected to the first portion,
the second portion includes a first slit where the transparent electrode of the array substrate is provided, and
the counter-electrode includes a second slit where the transparent electrode of the counter-substrate is provided, in the surrounding area.

11. The display device of claim 4, wherein
the array substrate includes a plurality of scanning lines provided in the display area, and a first wiring portion provided in the surrounding area and connected to the plurality of scanning lines, and
the transparent electrode is formed along the first wiring portion.

12. The display device of claim 11, wherein
the array substrate further includes a second wiring portion which is provided in the surrounding area and to which a voltage of the same potential as the counter-electrode is applied, and
the transparent electrode is formed along the second wiring portion.

13. The display device of claim 4, wherein
the counter-substrate includes a light shielding layer overlapping with the transparent electrode and formed in a grating shape.

14. The display device of claim 13, wherein
the array substrate includes a plurality of scanning lines provided in the display area, a plurality of signal lines provided in the display area and intersecting the plurality of scanning lines, and a first wiring portion provided in the surrounding area and connected to the plurality of scanning lines, and
the light shielding layer overlaps with the plurality of scanning lines and the plurality of signal lines, in the display area, and overlaps with the first wiring portion in the surrounding area.

15. The display device of claim 14, wherein
the array substrate further includes a second wiring portion which is provided in the surrounding area and to which a voltage of the same potential as the counter-electrode is applied, and
the light shielding layer overlaps with the second wiring portion.

16. The display device of claim 13, wherein
the area of an aperture of the light shielding layer in the display area is substantially equal to the area of an aperture of the light shielding layer in the surrounding area.

17. The display device of claim 1, further comprising:
a light source emitting light to the display panel, wherein
the display panel further includes a first side surface located between the light source and the display area, a second side surface facing in a direction opposite to the first side surface, and a third side surface and a fourth side surface connecting with the first side surface and the second side surface, and
the transparent electrode is provided between the display area and the second side surface, between the display area and the third side surface, and between the display area and the fourth side surface, in the surrounding area.

18. The display device of claim 17, wherein
the transparent electrode is further provided between the display area and the first side surface, in the surrounding area.

19. The display device of claim 1, further comprising:
a control circuit capable of controlling a voltage applied to the transparent electrode.

20. The display device of claim 19, further comprising:
a temperature sensor detecting an ambient temperature of the liquid crystal layer, wherein
the control circuit controls the voltage applied to the transparent electrode, based on the temperature detected by the temperature sensor.
